(19) United States
(12) Patent Application Publication
(10) Pub. No.: US 2002/0095340 A1
(43) Pub. Date: Jul. 18, 2002

(54) Method of processing advertisements on a computerized network terminal and terminal for implementing the method

(76) Inventor: Michel Vermande, Montreuil Sur Epte (FR)

Correspondence Address: QUARLES & BRADY LLP, 411 E. WISCONSIN AVENUE, SUITE 2040, MILWAUKEE, WI, 53202-4497, US

(21) Appl. No.: 10/041,184

(22) Filed: Jan. 8, 2002

(30) Foreign Application Priority Data
Jan. 17, 2001 (FR) 01 00589

(51) Int. Cl. G06F 17/60

(52) U.S. Cl. 705/14

(57) ABSTRACT

In the method of the invention for processing advertisements (1) sent at the request of an advertiser to a data processing terminal (6) of a computerized network, when the terminal is communicating over the network and when it receives advertisements, it stores them in a memory (13) without displaying them, so as to be able, when the communication is severed, to display (11) them and to view them while browsing around the memory (13).

The terminal (6) comprises a WAP services module (9), an advertisements memory (13), means (14) for managing the advertisements memory (13) and means (7, 9, 12, 14, 20) for browsing around the advertisements memory (13).

The invention is eminently applicable to WAP cellular terminals.

With a data processing terminal such as a personal computer, when browsing around a computerized network such as the Internet, advertising commercials are received which hide a part of the screen, but only a small part. There is therefore not much loss of information. And then, they can be made to disappear.

With a WAP terminal of a cellular radiotelephony network, although the screen is larger than those of conventional terminals, it is still too small for these advertisements not to be a hindrance.

Whether they mask a small relative part of the information, in the case of a personal computer, or a larger relative part, in the case of a telephone terminal, the applicant has sought to evade advertisements while communicating over the network, although without regarding them as a nuisance and the applicant therefore proposes his invention.

The invention relates firstly to a method of processing advertisements sent at the request of an advertiser to a data processing terminal of a computerized network, in which, when the terminal is communicating over the network and when it receives advertisements, it stores them in a memory without displaying them, so as to be able, when the communication is severed, to display them and to view them while browsing around the memory, characterized in that, if during browsing around the advertisements storage memory, so as to view same, an advertisement containing a link with an external site is displayed, a communication is automatically re-established so as to be able to visit the site.

By virtue of the invention, the communications are not disturbed by the momentarily undesirable “compulsory” advertisements, the users being able to view them as they please, selectively and when they see fit. The advertisements are no longer imposed, nor resented.

Advantageously, the advertisements are marked so as to be able to distinguish them from other data of the network and the advertisements viewed are logged for allocation of rewards to the user of the processing terminal.

By virtue thereof, the advertisers can correctly measure the impact of their advertisements on users. Likewise, the operator of the network can thus obtain an indicator of the manner in which the users perceive his role as intermediary.

It is beneficial to send advertisements to a terminal by dint of its SIM card to which are attached advertising rights.

The invention also relates to a data processing terminal of a computerized network, comprising a man/machine interface assembly, a connector for SIM card, a module for browsing around a menu and a WAP services module, terminal characterized in that it furthermore comprises an advertisements memory, means for managing the advertisements memory and means for browsing around the advertisements memory, characterized in that there are provided automatic means of establishing communication over the network, which are controlled by the means for managing the advertisements memory.

The invention will be better understood with the aid of the following description of the method and of the terminal, with reference to the appended drawing, in which:

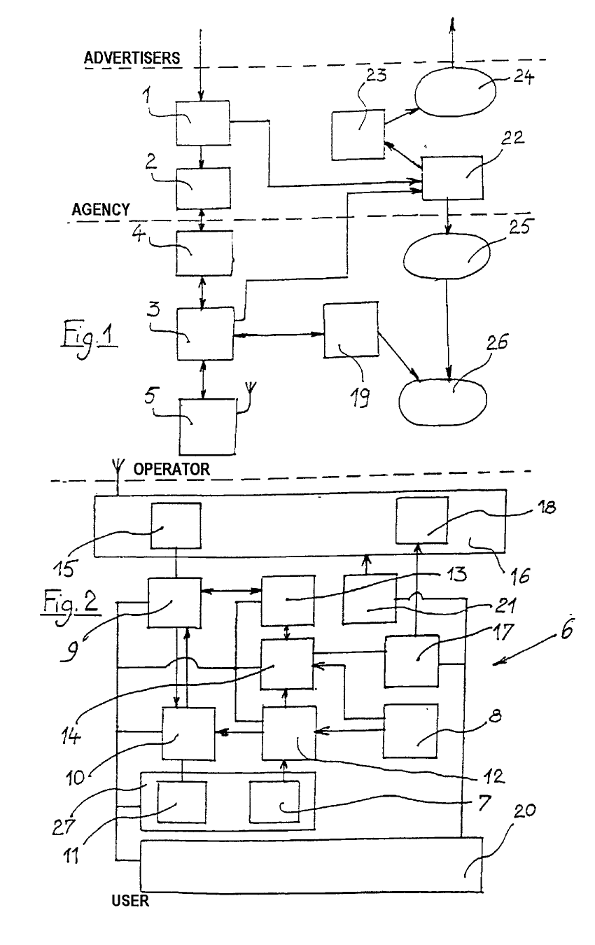

FIG. 1 is a blockwise illustration of the method of the invention, in the worlds of advertising and of a computerized network operator and

FIG. 2 is a block diagram of a data processing terminal of the network.

The invention applies essentially to the processing of advertising commercials. However, it may receive other applications and relate equally well to the processing of pages of a catalogue, price list or any other commercial document. This is why, hereinbelow, only advertisements will be considered.

1—Sending of advertisements to and displaying of advertisements on data processing terminals

1.1 World of advertising

The advertisers have prepared batches of advertising commercials which they forward, and here for simplicity, to a single advertising agency which stores them in a database 1. With the advertisements of the base 1, the agency feeds an advertisements server 2, connected to a computerized network, here the Internet network.

1.2 World of the operator of the WAP advertisements service

On requests from the agency, representing its advertisers, to an operator of the WAP advertisements service of the Internet network, the agency sends, to an advertisements messaging centre 3 of the operator, selected advertisements destined for particular users determined by their SIM cards (subscriber identification module) to which are attached advertising rights, these being sent by way of a gateway 4 of the Internet network. When the users thus determined communicate over their cellular radiotelephony network to which they are subscribers, the messaging centre 3 sends them selected advertisements, by way here of base stations 5 of the radiotelephony network. The advertisements sent are marked for reasons dealt with later.

1.3 World of a user who owns a data processing WAP terminal

A user therefore owns a WAP terminal 6.

1.3.1 Reception of advertisements

By way of a keypad 7 of a man/machine interface assembly 27 and of a module 12 for browsing around a menu, initialized by his SIM card disposed in a connector for SIM card 8, the user activates a WAP services module 9 of his terminal, by way of a switching block 10 isolating, for these advertisements only, the screen 11 from the interface 27 of the terminal.

The advertisements received on the reception pathway 15 of the radio block 16 of the terminal 6, which are marked so as to be able to distinguish them from the other data of the network, are then stored in an advertisements memory 13, under the control of a module 14 for managing this memory 13 supervised by the SIM card 8 and the browsing module 12. The memory 13 is continually updated during communications and WAP browsing.

1.3.2 Display and viewing of advertisements

When the user has interrupted his WAP communications, with the aid of the keypad 7, of the WAP module 9, of the management module 14 and of the browsing module 12 comprising a program for browsing around the advertisements storage memory 13, on the one hand, and of the supervisor 20 of the terminal, to which the components of the terminal are linked, on the other hand, the user can browse around the advertisements memory 13 and display on the screen 11 the advertisements which he wishes to view.

In the case, in a displayed advertisement, of a place with an external site, the block 21 for instigating communication of the terminal 6, linked to the radio block 16, under the control of the management module 14 and of the supervisor 20, automatically re-establishes the communication of the terminal so as to visit the site.

2. Logging of displays and allocating of rewards

They relate equally well to the world of the user and to those of the operator and advertising. The advertisements which are displayed and viewed by the user are logged for allocation of rewards. Logging may be performed in tandem with display or subsequently, during particular steps.

The memory management module 14 supervises a module, for logging 17 which, by way of the advertised pathway 18 of the radio block 16 of the terminal 6 and of the associated base station 5, forwards a message to the operator, to his advertisements messaging centre 3. A message contains the references of the advertisements viewed by the user, by virtue of their marking, as well as the references of his SIM card, which is identified in a HLR identification register 19 (Home Locator Register) of the operator. The messaging centre 3 of the operator is also linked to a block 22 for metering the displays of the advertising agency linked to the database 1 and which feeds a base of this information 23.

Using the information base 23, the advertising agency can invoice (24) its advertisers.

The operator metering block 22 also supplies a block for allocating rewards 25 of the operator with the data which will make it possible, in combination with the data of the identification register 19, to credit (26) the user.

1. Method of processing advertisements (1) sent at the request of an advertiser to a data processing terminal (6) of a computerized network, in which, when the terminal is communicating over the network and when it receives advertisements, it stores them in a memory (13) without displaying them, so as to be able, when the communication is severed, to display (11) them and to view them while browsing around the memory (13), characterized in that, if during browsing around the advertisements storage memory (13), so as to view same, an advertisement containing a link with an external site is displayed (11), a communication is automatically re-established (21) so as to be able to visit the site.

2. Method according to claim 1, in which the advertisements are marked so as to be able to distinguish them from other data of the network.

3. Method according to claim 2, in which the advertisements viewed are logged for allocation (25, 26) of rewards to the user of the processing terminal (6).

4. Method according to claim 1, in which the advertisements are sent to a terminal (6) by dint of its SIM card (8).

5. Data processing terminal of a computerized network, comprising a man/machine interface assembly (27), a connector for SIM card (8), a module (12) for browsing around a menu and a WAP services module (9), terminal characterized in that it furthermore comprises an advertisements memory (13), means (14) for managing the advertisements memory (13) and means (7, 9, 12, 14, 20) for browsing around the advertisements memory (13), characterized in that there are provided automatic means (20, 21) of establishing communication over the network, which are controlled by the means (14) for managing the advertisements memory (13).
